(19) United States
(12) Patent Application Publication
(10) Pub. No.: US 2012/0114796 A1
(43) Pub. Date: May 10, 2012

(54) METHOD OF MANUFACTURING POROUS VEGETABLE FILLER FOR USE IN FOAMING PROCESS

(76) Inventors: Chi-Feng Lai, Dali City (TW); Yun-Tong Ou, Taiping City (TW); David Wen, Taipei City (TW)

(21) Appl. No.: 12/941,095

(22) Filed: Nov. 8, 2010

(51) Int. Cl. A23F 5/04; A23F 5/00

(52) U.S. Cl. 426/45; 426/466

(57) ABSTRACT

A method of manufacturing a porous vegetable filler for use in a foaming process mainly comprises exposing discarded coffee grounds to sunlight to a moisture content of 5%-15%; then baking the coffee grounds after solarization using a dryer at 120° C.-350° C. for 1 to 4 hours; finally grinding the baked coffee grounds to a size of less than 1000 mesh to obtain a porous vegetable filler for use in a foaming process.

### FIELD OF THE INVENTION

The present invention relates to a filler used in a foaming process, and more particularly to a method of manufacturing a porous vegetable filler for use in a foaming process.

### BACKGROUND OF THE INVENTION

Currently, in a common manufacturing process for producing foaming materials (such as EVA foams), chemical additives are one of the main ingredients in the formulations, which can effectively reduce the cost of raw materials and can further be used to reinforce the physical properties of foam materials. Therefore, it can be said that the chemical additives are very important auxiliary agents in the production of foam materials.

EVA foam is a type of closed cell structure and hence it absorbs neither odor nor moisture. This is a major disadvantage of current EVA and rubber foams.

In view of the above-described circumstances, how to solve the above-mentioned problems is the most important subject of the present invention. As a result, various considerations and attempts have been made continuously by the inventors to achieve the invention.

### SUMMARY OF THE INVENTION

A first object of the present invention is to provide a method of manufacturing a porous vegetable filler for use in a foaming process, which can be implemented at a low cost and in which the wastes of natural plant products are recycled again and can be used in a foaming process.

A second object of the present invention is to provide a method of manufacturing a porous vegetable filler for use in a foaming process, in which the porous vegetable filler has excellent moisture absorption and deodorization effect.

In order to achieve the foregoing objects, the present invention provides a method of manufacturing a porous vegetable filler for use in a foaming process comprising the following steps:
a. recovering and collecting discarded coffee grounds, exposing the coffee grounds to sunlight to a moisture content of 5%-15%;
b. then baking the coffee grounds after solarization using a dryer at 120° C.-350° C. for 1 to 4 hours; and
c. finally grinding the baked coffee grounds to a size of less than 1000 mesh to obtain a porous vegetable filler for use in a foaming process.

Furthermore, according to the above-mentioned method, in step a, the coffee grounds recovered and collected can be first submerged and fermented in water containing 1.5% plant hydrolases for 7 to 8 hours, followed by exposure to sunlight and the other subsequent steps.

The above objects and advantages of the present invention will become apparent from the following detailed description of preferred embodiments of the invention when read in connection with the accompanying drawings.

Of course, the present invention allows different arrangements in some other cases, but the preferred embodiments will be described in detail herein.

### BRIEF DESCRIPTION OF THE DRAWINGS

FIG. 1 is a flow chart of the steps of a preferred embodiment of the present invention.

FIG. 2 is a flow chart of the steps of another preferred embodiment of the present invention.

### DETAILED DESCRIPTION OF THE PREFERRED EMBODIMENTS

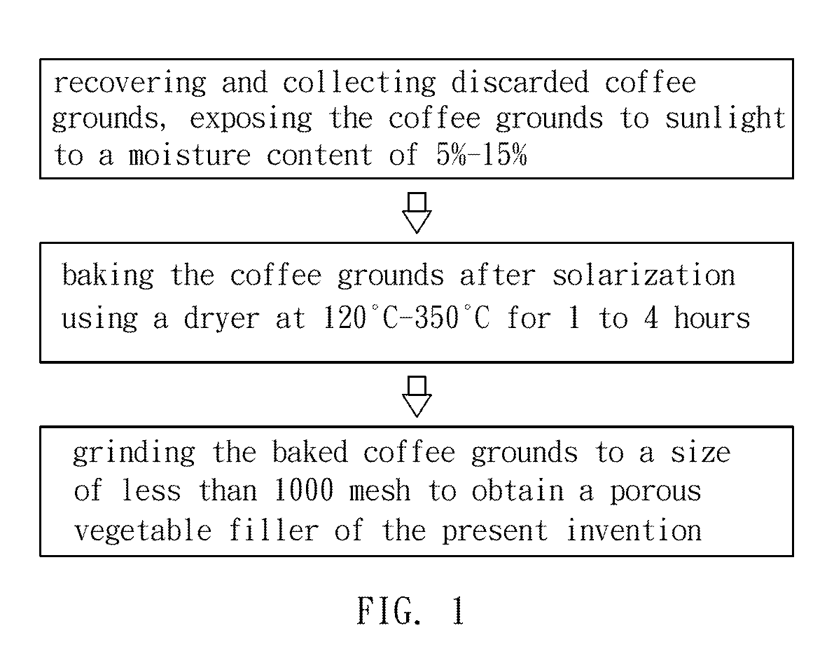

Referring to FIG. 1, there is illustrated a preferred embodiment of a method of manufacturing a porous vegetable filler for use in a foaming process according to the present invention.

In this embodiment, coffee grounds which remain after brewing coffee are used as the raw material of the vegetable filler according to the present invention. Since roasted coffee beans are substantially carbonized to have a certain strength and intrinsically have vegetable fibers, they can provide an increased supporting effect.

Furthermore, coffee beans themselves contain more than hundreds of chemical substances, one of the more important of which is well-known caffein, and so many chemical substances will be completely released when brewed with hot water or in the molten state, so that a porous structure is formed on each coffee particle. These pores can achieve moisture absorption and deodorization effect. The principle is the same as that on which coffee grounds are packaged to serve as a moisture-proof deodorant product hanging in the toilet.

To substitute the coffee grounds for chemical additives used in a foaming process, the following processing steps must be performed:

a. Firstly, discarded coffee grounds are recovered and collected, and the coffee grounds recovered and collected are exposed to sunlight to a moisture content of 5%-15% for the initial dehydration. Prior to the next step, the coffee grounds after the completion of the solarization can be filled in a predetermined container for storage and sealing to prevent moisture regain;

b. Then, the coffee grounds after solarization is baked using a dryer at 120° C.-350° C. for 1 to 4 hours. In this embodiment, the dryer is set to bake the coffee grounds after solarization at 120° C. for 2 to 3 hours, whereby the coffee grounds can be completely dehydrated and further carbonized;

c. Finally, a grinding operation is performed on the baked coffee grounds, so that the coffee grounds are ground to a size of less than 1000 mesh to obtain a porous vegetable filler for use in a foaming process.

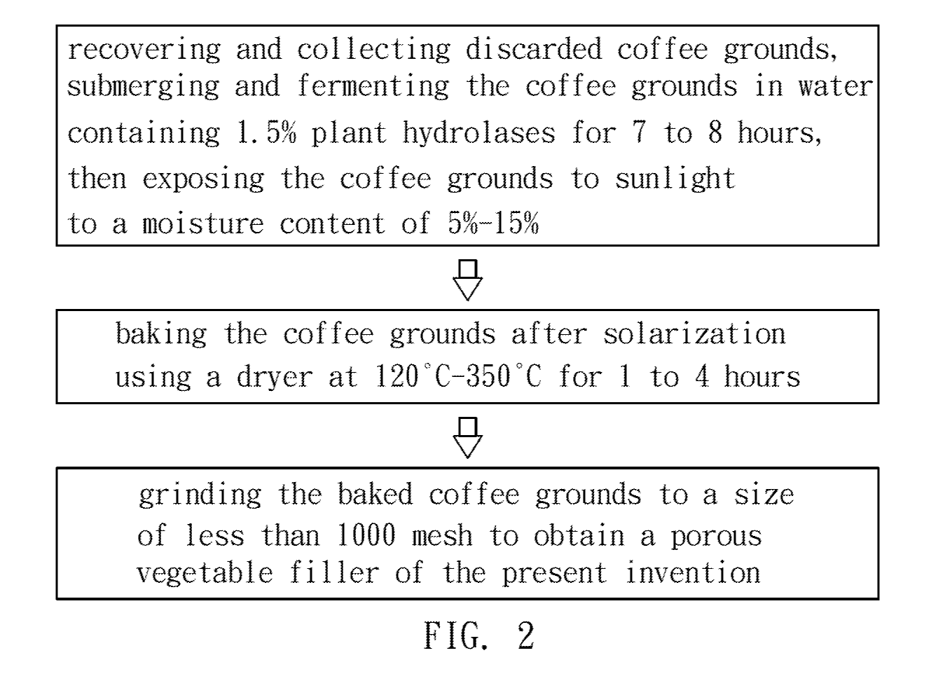

Furthermore, as shown in FIG. 2, there is illustrated another preferred embodiment of the present invention. This embodiment is mainly based on the manufacturing method of the above-described first embodiment, and in step a, the coffee grounds recovered and collected are first submerged and fermented in water containing 1.5% plant hydrolases for 7 to 8 hours, followed by exposure to sunlight and the other subsequent steps. As shown in FIG. 2, a porous vegetable filler can be similarly manufactured. By means of the method according to this embodiment, the texture of the coffee grounds is softened due to fermentation and decomposition by plant hydrolases and is advantageous to the subsequent processing steps, so that the porous vegetable filler made thereby is more suitable for commercial use and mass production.

As an example, in the production of EVA insoles, a porous vegetable filler of the present invention, and other auxiliary agents such as a foaming agent, a cross linking agent, etc. are mixed under stirring at a temperature below 115° C. for 15 to 20 minutes. This step allows all the materials to be preliminarily molten and mixed, and it must be controlled at a temperature below 115° C. to avoid premature cross-linking of the cross linking agent and premature foaming of the foaming agent.

Then, the molten materials are fed into a roll stand and formed into sheets at 110-120° C. during 10-15 minutes. The roller gap of the roll stand can be adjusted so that the molten materials can be mixed more uniformly, and then the mixed molten materials are fed into a calender to form sheets of 3 mm/5 min at 25° C.

The sheets are placed into a foaming stand and foamed at 155-170° C. and a pressure of 150-160 kg/cm² for 30 to 40minutes. Also, cross linking and foaming reactions occur in this step to produce the EVA foam.

After the foaming is completed, the EVA foam is taken out from the foaming stand and tailored to the thickness required for the insole using a cutting machine, followed by Phylon molding in which the molding temperature is 150° C., the heating time is from 6 to 9 minutes, and the cooling time is from 9 minutes 30 seconds to 12 minutes.

Finally, after the Phylon molded EVA foam is cut into the insole of a predetermined size, the manufacture of an EVA insole is completed.

A comparison of the physical properties of an EVA insole manufactured in accordance with the above steps and a general EVA insole manufactured from chemical fillers is shown as follows.

| | general EVA insole | the present insole |
|---|---|---|
| Hardness | 45 | 43-46 |
| Asker C | | |
| Specific Gravity | 0.16 | 0.1-0.18 |
| g/cm² | | |
| Tensile Strength | 18.6 | 18.0-18.9 |
| kg/cm² | | |
| Elongation % | 220 | 200-220 |
| Tear Resistance | 10 | 10-15 |
| kg/cm | | |
| Compression Set % | 65 | 60-70 |
| Shrink % | 0.48 | 0.43-0.45 |
| Rebound % | 45 | 45-48 |

From the result of the comparison between the EVA insole manufactured from a vegetable filler of the present invention and the EVA insole manufactured from a chemical filler (calcium carbonate) as a control group, it is demonstrated that the foam which includes an amount of coffee grounds in substitution for the same amount of the chemical filler (calcium carbonate) not only has no significant difference in the physical properties but also can be produced by the same facilities and procedures. Therefore, the coffee grounds can directly substitute chemical fillers without changes.

Tests are performed on a general EVA insole (as a control group) and the present insole after real jogging, wherein the test conditions are jogging for 1 hour each time at a temperature higher than 30° C. with a test period of 14 days.

### Test Results:

| | general EVA insole | the present insole |
|---|---|---|
| filler | calcium carbonate | coffee grounds |
| usage amount | 30 PHR | 20-50 PHR |
| procedures | the same | the same |
| facilities | the same | the same |
| physical | the same | the same |
| properties | | |
| odor of the insole | smelly-very smelly | not smelly, |
| after jogging and | | with a little |
| sweating | | coffee flavor |
| moisture of the | very wet | dry and not wet |
| insole | | |

It is clear from the above test results that the present invention can achieve excellent moisture absorption and deodorization effect due to the porous structure and coffee flavor of the coffee grounds themselves. Moreover, because of the use of DCP as a cross linking agent, general EVA foams have a strong, pungent odor. However, in the present invention, a vegetable filler made from coffee grounds is added, so the residual coffee flavor can effectively neutralize the strong, pungent odor of DCP. This is another advantage of the present invention.

It is to be understood that the disclosure of the above-mentioned embodiments is illustrative only and the invention is not limited to the disclosed embodiments, and therefore all changes in values or substitution by equivalent elements should still be included within the scope of the invention.

Those skilled in the art can now appreciate from the foregoing detailed description that above-described objects can be achieved by the present invention, and the application for a patent is duly filed accordingly.

What is claimed is:

1. A method of manufacturing a porous vegetable filler for use in a foaming process comprising the following steps:
a. recovering and collecting discarded coffee grounds, exposing the coffee grounds to sunlight to a moisture content of 5%-15%;
b. baking the coffee grounds after solarization using a dryer at 120° C.-350° C. for 1 to 4 hours; and
c. grinding the baked coffee grounds to a size of less than 1000 mesh to obtain a porous vegetable filler for use in a foaming process.

2. The method of manufacturing a porous vegetable filler for use in a foaming process as described in claim 1, wherein in step a, the coffee grounds recovered and collected are submerged and fermented in water containing 1.5% plant hydrolases for 7 to 8 hours, followed by exposure to sunlight and the other subsequent steps.

3. The method of manufacturing a porous vegetable filler for use in a foaming process as described in claim 1, wherein in step b, the dryer is set to bake the coffee grounds after solarization at 120° C. for 2 to 3 hours.

4. The method of manufacturing a porous vegetable filler for use in a foaming process as described in claim 2, wherein in step b, the dryer is set to bake the coffee grounds after solarization at 120° C. for 2 to 3 hours.
